(19) United States
(12) Patent Application Publication
(10) Pub. No.: US 2025/0007298 A1
(43) Pub. Date: Jan. 2, 2025

(54) CHARGING SYSTEM

(71) Applicant: 3M INNOVATIVE PROPERTIES COMPANY, St. Paul, MN (US)

(72) Inventors: Darin K. Thompson, Huntersville, NC (US); William B. Howell, Pineville, NC (US); David A. Amero, Calgary (CA); Ivan M. Delamer, Calgary (CA)

(21) Appl. No.: 18/706,064

(22) PCT Filed: Oct. 27, 2022
(86) PCT No.: PCT/IB2022/060341

§ 371 Date: Apr. 30, 2024

Related U.S. Application Data
(60) Provisional application No. 63/263,629, filed on Nov. 5, 2021.

(51) Int. Cl. H02J 7/00; H02J 7/34; H02J 50/10; H02J 50/20

(52) U.S. Cl. CPC H02J 7/00034; H02J 7/00304; H02J 7/342; H02J 50/10; H02J 50/20

(57) ABSTRACT

The present disclosure provides a charging system. The charging system includes a first device. The first device includes a first power interface. The first device further includes a first communication module. The first communication module includes at least one first transceiver. The first device further includes a second communication module. The second communication module includes at least one second transceiver. The first device further includes an intrinsic barrier disposed between and physically separating the first communication module from the second communication module. The first communication module and the second communication module are configured to wirelessly exchange data signals therebetween. The charging system further includes a second device including a second power interface. The first power interface and the second power interface are configured to be electrically connected to each other to transfer electrical power between the first and second devices.

### TECHNICAL FIELD

The present disclosure relates to an intrinsically safe charging system.

### BACKGROUND

Some electronic devices may require exchange of electric power as well as exchange of data signals with one another. In some cases, there may be a requirement for a high-speed data transmission between the electronic devices. Conventionally, the electronic devices may include intrinsic safety circuits including safety components that may limit a maximum electrical power within the electronic devices in order to protect the electronic devices from an overcurrent, a surge current, and other electrical overload conditions. However, the safety components of the intrinsic safety circuit may also inhibit the high-speed data transmission between the electronic devices.

### SUMMARY

In a first aspect, the present disclosure provides a charging system. The charging system includes a first device. The first device includes a first power interface. The first device further includes a first communication module. The first communication module includes at least one first transceiver. The first device further includes a second communication module. The second communication module includes at least one second transceiver. The first device further includes an intrinsic barrier disposed between and physically separating the first communication module from the second communication module. The first communication module and the second communication module are configured to wirelessly exchange data signals therebetween. The charging system further includes a second device including a second power interface. The first power interface and the second power interface are configured to be electrically connected to each other to transfer electrical power between the first and second devices.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein is more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labelled with the same number.

FIG. 1A illustrates a schematic block diagram of a charging system, according to an embodiment of the present disclosure;

FIG. 1B illustrates a schematic block diagram of a charging system, according to another embodiment of the present disclosure;

FIG. 2A illustrates a schematic block diagram of a charging system, according to another embodiment of the present disclosure;

FIG. 2B illustrates a schematic block diagram of a charging system, according to another embodiment of the present disclosure;

FIG. 3A illustrates an exemplary representation of the charging system of FIG. 1A; and

FIG. 3B illustrates a detailed schematic block diagram of the charging system of FIG. 3A.

### DETAILED DESCRIPTION

In the following description, reference is made to the accompanying figures that form a part thereof and in which various embodiments are shown by way of illustration. It is to be understood that other embodiments are contemplated and is made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, the term “an article of personal protective equipment (PPE)” may include any type of equipment or clothing that may be used to protect a user from hazardous or potentially hazardous environmental conditions. In some examples, one or more individuals, such as the users, may utilize the article of PPE while engaging in tasks or activities within the hazardous or potentially hazardous environment. Examples of the articles of PPE may include, but are not limited to, hearing protection (including ear plugs and car muffs), respiratory protection equipment (including disposable respirators, reusable respirators, powered air purifying respirators, self-contained breathing apparatus and supplied air respirators), facemasks, oxygen tanks, air bottles, protective eyewear, such as visors, goggles, filters or shields (any of which may include augmented reality functionality), protective headwear, such as hard hats, hoods or helmets, protective shoes, protective gloves, other protective clothing, such as coveralls, aprons, coat, vest, suits, boots and/or gloves, protective articles, such as sensors, safety tools, detectors, global positioning devices, mining cap lamps, fall protection harnesses, exoskeletons, self-retracting lifelines, heating and cooling systems, gas detectors, and any other suitable gear configured to protect the users from injury. The articles of PPE may also include any other type of clothing or device/equipment that may be worn or used by the users to protect against extreme noise levels, extreme temperatures, fire, reduced oxygen levels, explosions, reduced atmospheric pressure, radioactive, and/or biologically harmful materials.

As used herein, the term “hazardous or potentially hazardous environments” may refer to environments that include hazardous or potentially hazardous environmental conditions. The hazardous or potentially hazardous environments may include, for example, chemical environments, biological environments, nuclear environments, fires, industrial sites, construction sites, agricultural sites, mining sites, or manufacturing sites.

As used herein, the term “hazardous or potentially hazardous environmental conditions” may refer to environmental conditions that may be harmful to a human being, such as high noise levels, high ambient temperatures, lack of oxygen, presence of explosives, exposure to radioactive or biologically harmful materials, and exposure to other hazardous substances. Depending upon the type of safety equipment, environmental conditions and physiological conditions, corresponding thresholds or levels may be established to help define hazardous and potentially hazardous environmental conditions.

As used herein, the terms(s) “electrically connecting” and/or “electrically connected” refer to direct coupling between components and/or indirect coupling between components via one or more intervening electric components, such that an electric signal can be passed between the two components. As an example of indirect coupling, two components can be referred to as being electrically connected, even though they may have an intervening electric component between them which still allows an electric signal to pass from one component to the other component. Such intervening components may comprise, but are not limited to, wires, traces on a circuit board, and/or another electrically conductive medium/component.

As used herein, the term “communicably coupled to” refers to direct coupling between components and/or indirect coupling between components via one or more intervening components. Such components and intervening components may comprise, but are not limited to, junctions, communication paths, components, circuit elements, circuits, functional blocks, and/or devices. As an example of indirect coupling, a signal conveyed from a first component to a second component may be modified by one or more intervening components by modifying the form, nature, or format of information in a signal, while one or more elements of the information in the signal are nevertheless conveyed in a manner than can be recognized by the second component.

As used herein, the term “signal,” includes, but is not limited to, one or more electrical signals, optical signals, electromagnetic signals, analog and/or digital signals, one or more computer instructions, a bit and/or bit stream, or the like.

As used herein, the term “a power interface” may refer to an electrical device or a component configured to receive an electric power and transmit a portion of the received electric power to other devices or components. The power interface may receive the electric power from a power source. In some cases, the power interface may be electrically connected to the power source through physical connections. In other words, the power interface may receive the electric power from the power source through a direct transmission of charged particles between the power interface and the power source. The power interface may be electrically connected to the power source through female connectors, such as receptacles, or through male connectors, such as plugs. The power interface may include technologies such as Universal Serial Bus (USB), micro-USB, mini-USB, C-type USB, 30-pin, Lightning, and the like. In some cases, the power interface may be galvanically isolated from the power source, and the power interface may receive the electric power through wireless power transmission. The wireless power transmission may be through near-field technologies such as inductive coupling and capacitive coupling. The wireless power transmission may be through far-field technologies by using electromagnetic radiation, such as millimeter waves, microwaves, lasers, and the like. In some aspects, millimeter waves are electromagnetic (radio) waves typically defined to lie within the frequency range of 30 to 300 GHz. In some aspects, the microwave band is just below the millimeter-wave band and is typically defined to cover the 3 to 30 GHz range.

As used herein, the term “galvanically isolated” refers to any two components of an electrical system, such that charge carrying particles cannot move from one component to another, i.e., there is no electric current flowing directly from the one component to the other. However, energy and/or other signals may be exchanged between the one component and the other component by other means, such as capacitance, induction, electromagnetic waves, optical, acoustic, or mechanical means.

An electronic device may include intrinsic safety circuit(s) to ensure that the electronic device is intrinsically safe (IS). The intrinsic safety circuit may include intrinsic safety components, such as fuses, resistors, diodes, etc. The electronic device may include the intrinsic safety circuit to limit a maximum electrical power in the electronic device in order to prevent damaging electrical conditions, such as an overcurrent, a surge current, or other electrical overloads. Thus, the intrinsic safety circuit may prevent damage to the electronic device.

In some cases, a first electronic device including intrinsic safety circuits may be required to exchange power as well as data signals with a second electronic device. The intrinsic safety circuits may limit a data exchange rate between the intrinsically safe first electronic device and the second electronic device. In other words, the intrinsic safety circuits may inhibit high-speed data transmission between the first and second electronic devices. The high-speed data transmission may be required for timely transmission of large size data, such as video data, or audio data, between the first and second electronic devices.

In an aspect, the present disclosure provides a charging system. The charging system includes a first device. The first device includes a first power interface. The first device further includes a first communication module. The first communication module includes at least one first transceiver. The first device further includes a second communication module. The second communication module includes at least one second transceiver. The first device further includes an intrinsic barrier disposed between and physically separating the first communication module from the second communication module. The first communication module and the second communication module are configured to wirelessly exchange data signals therebetween. The charging system further includes a second device including a second power interface. The first power interface and the second power interface are configured to be electrically connected to each other to transfer electrical power between the first and second devices.

As the intrinsic barrier is disposed between and physically separates the first communication module from the second communication module, the first communication module and the second communication module may not require the intrinsic safety circuits including the intrinsic safety components to prevent the overcurrent, the surge current, or any other electrical overload from being transferred between the first communication module and the second communication module. Therefore, the data signals may be exchanged between the first communication module and the second communication module at a high data transfer rate while the first and second components are intrinsically safe.

Therefore, the intrinsic safety circuit provided in the first device or the second device in order to provide protection to the first device and the second device, against the overcurrent, the surge current or the other electrical overload conditions may not negatively affect the data exchange rate between the first device and the second device.

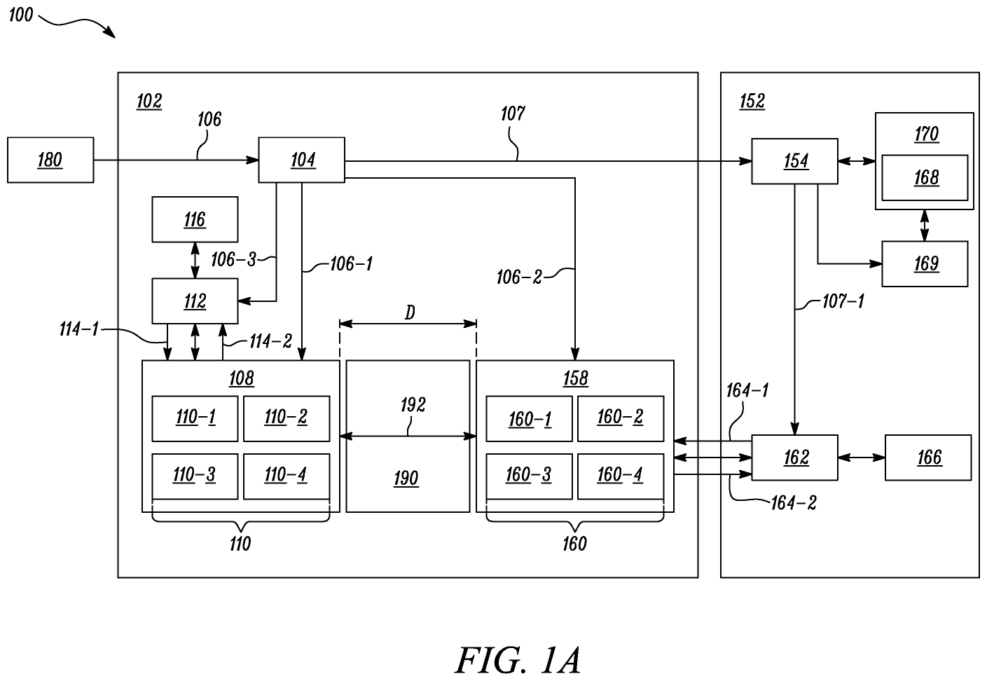

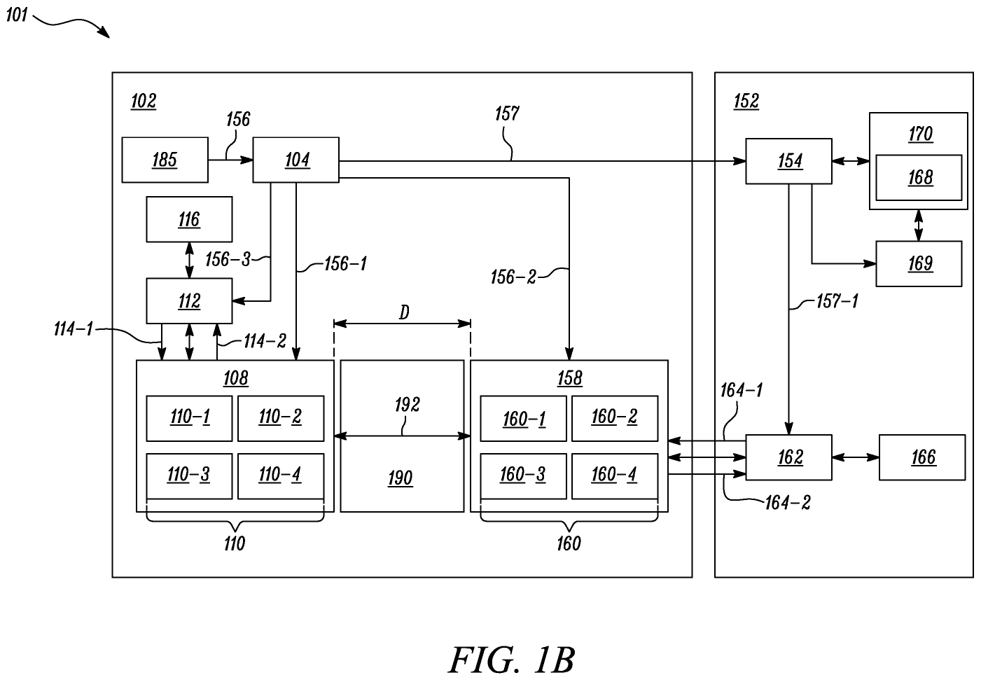

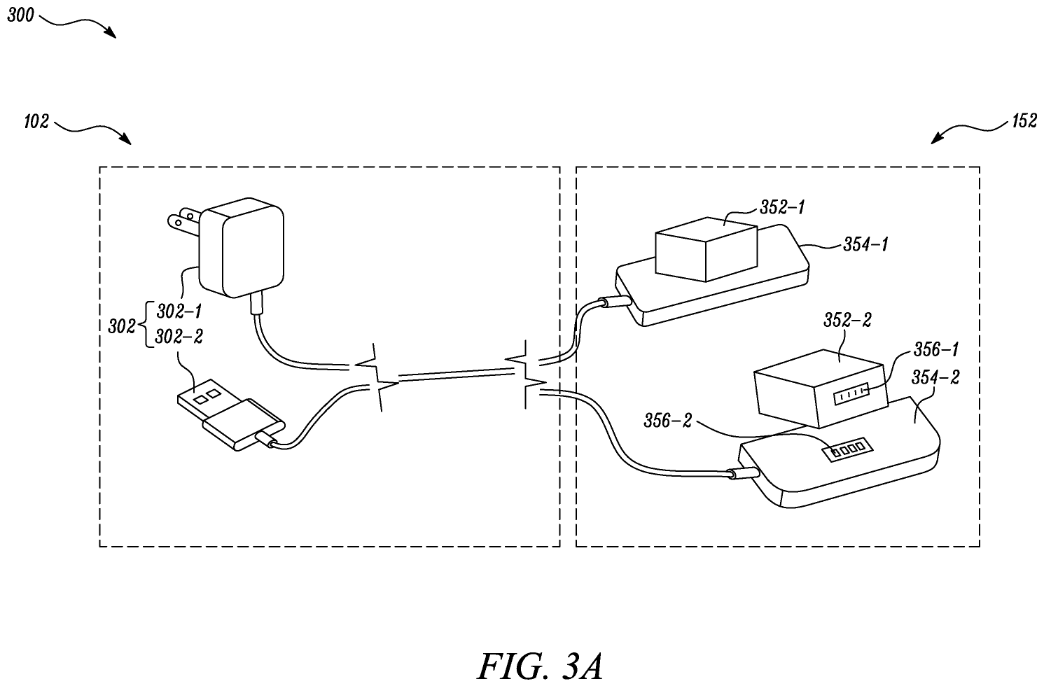

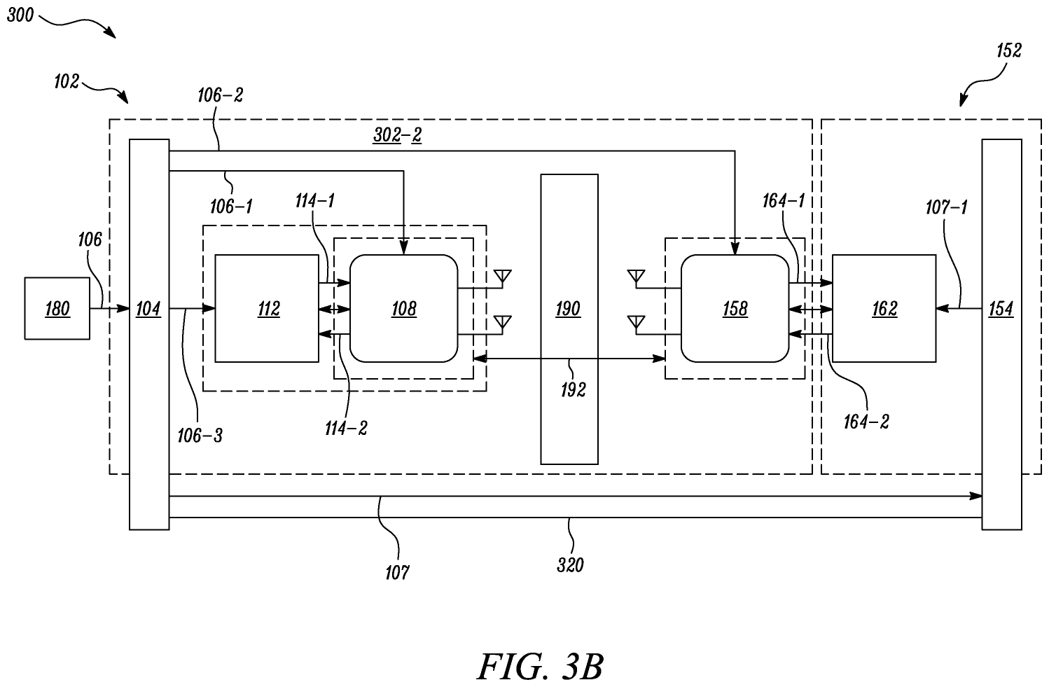

Referring to figures, FIG. 1A illustrates a schematic block diagram of a charging system 100, according to an embodiment of the present disclosure. The charging system 100 includes a first device 102. In some embodiments, the first device 102 may include an electronic device (e.g., first electronic devices 302 shown in FIG. 3A). In some embodiments, the electronic device may include, without limitations, a USB adapter, charging adapter, a laptop, a mobile phone, a tablet, a camera, a personalized digital assistant, and the like.

The first device 102 includes a first power interface 104. In some embodiments, the first power interface 104 of the first device 102 is configured to be electrically connected to an external power source 180. The first power interface 104 of the first device 102 is further configured to receive an external electrical power 106 from the external power source 180. In some embodiments, the external power source 180 may include a direct current (DC) power source, such as a battery, a fuel cell, an ultracapacitor, and/or any other suitable voltage source. In some embodiments, the battery may be any type of battery, such as a lead acid battery, coin cells, a lithium-ion battery, a nickel-metal battery, and/or any other rechargeable battery. In some embodiments, the ultracapacitor may include a supercapacitor, an electrochemical double layer capacitor, and/or any other electrochemical capacitor with high energy density. In some embodiments, the external power source 180 may include an alternating power (AC) power source. In some embodiments, the external power source 180 may include an electrical socket.

In some embodiments, the first power interface 104 of the first device 102 may be galvanically isolated from the external power source 180. In such embodiments, the first power interface 104 of the first device 102 may be configured to receive the external electrical power 106 from the external power source 180 wirelessly.

The first device 102 further includes a first communication module 108. In some embodiments, the first power interface 104 may be configured to transmit a portion 106-1 of the external electrical power 106 to the first communication module 108. The first communication module 108 includes at least one first transceiver 110.

In some embodiments, the at least one first transceiver 110 may be a near-field magnetic induction (NFMI) transceiver. In such embodiments, the at least one first transceiver 110 may transmit and/or receive data signals (e.g., data signals 114-1 and/or data signals 114-2) through an NFMI network.

NFMI is a short-range wireless technology where communication between any two components may occur through a tightly coupled magnetic field. NFMI may be human body friendly, reliable, secure, and a power efficient method of wireless communication. A modulated signal is transmitted by a transceiver of one component in the form of a magnetic field. The magnetic field induces a voltage on a transceiver of another component, which may be measured by an NFMI transceiver of the other component. A power density of NFMI signals attenuates at a rate inversely proportional to a distance between the transceivers of the two components. This type of wireless transmission may be referred to as a near-field communication (NFC).

In some embodiments, the at least one first transceiver 110 may be a radio-frequency (RF) transceiver. In such embodiments, the at least one first transceiver 110 may transmit and/or receive data signals (e.g., the data signals 114-1 and/or the data signals 114-2) through an RF network. In some examples, the RF network may utilize an extremely high frequency (EHF) spectrum between about 30 Gigahertz (GHz) and about 300 GHz. The EHF spectrum may be a low power, short range, and high data rate transmission means. In some examples, the RF network may facilitate data transfer at a rate of up to about 6 gigabits per second. Such an RF network may exhibit improved wireless transmission, including through non-conducting materials, such as wood, glass, plastic, etc.

In some other examples, the RF network may utilize any other transmission spectra, such as one or more of an extremely low frequency (ELF), a super low frequency (SLF), an ultra-low frequency (ULF), a very low frequency (VLF), a low frequency (LF), a medium frequency (MF), a high frequency (HF), a very high frequency (VHF), an ultra-high frequency (UHF), or a super high frequency (SHF).

In some embodiments, the at least one first transceiver 110 includes a plurality of first transceivers. In the illustrated embodiment of FIG. 1A, the at least one first transceiver 110 includes four first transceivers 110-1, 110-2, 110-3, 110-4. The four first transceivers 110-1 to 110-4 may be collectively referred to as “the at least one first transceiver 110”, or “the plurality of first transceivers 110”.

In some embodiments, the plurality of first transceivers 110 may be substantially similar to each other. In some cases, the plurality of first transceivers 110 may include one or more primary transceivers (e.g., the first transceiver 110-1) and one or more secondary transceivers (e.g., the first transceivers 110-2 to 110-4). The one or more secondary transceivers may be utilized by the first communication module 108 when the one or more primary transceivers fail.

In some other embodiments, one or more first transceivers from the plurality of first transceivers 110 may be different from the others. In some cases, the first communication module 108 may transmit and/or receive the data signals through respective types of networks associated with the different types of the first transceivers 110.

The first device 102 further includes a second communication module 158. In some embodiments, the first power interface 104 may be configured to transmit a portion 106-2 of the external electrical power 106 to the second communication module 158. The second communication module 158 includes at least one second transceiver 160.

In some embodiments, the at least one second transceiver 160 may be a NFMI transceiver. In such embodiments, the at least one second transceiver 160 may transmit and/or receive data signals (e.g., data signals 192) through the NFMI network. Therefore, in some embodiments, each of the at least one first transceiver 110 and the at least one second transceiver 160 is the NFMI transceiver.

In some embodiments, the at least one second transceiver 160 may be a RF transceiver. In such embodiments, the at least one second transceiver 160 may transmit and/or receive data signals (e.g., the data signals 192) through an RF network. Therefore, in some embodiments, each of the at least one first transceiver 110 and the at least one second transceiver 160 is the RF transceiver.

In some embodiments, the at least one second transceiver 160 includes a plurality of second transceivers. In the illustrated embodiment of FIG. 1A, the at least one second transceiver 160 includes four second transceivers 160-1, 160-2, 160-3, 160-4. The four second transceivers 160-1 to 160-4 may be collectively referred to as “the at least one second transceiver 160”, or “the plurality of second transceivers 160”.

In some embodiments, the plurality of second transceivers 160 may be substantially similar to each other. In some cases, the plurality of second transceivers 160 may include one or more primary transceivers (e.g., the second transceiver 160-1) and one or more secondary transceivers (e.g., the second transceivers 160-2 to 160-4). The one or more secondary transceivers may be utilized by the second communication module 158 when the one or more primary transceivers fail.

In some other embodiments, one or more second transceivers from the plurality of second transceivers 160 may be different from the others. In some cases, the second communication module 158 may transmit and/or receive the data signals through respective types of networks associated with the different types of the second transceivers 160.

For example, the first transceivers 110-1, 110-2 may be NFMI transceivers and the second transceivers 160-1, 160-2 may be corresponding NFMI transceivers. Similarly, the first transceivers 110-3, 110-4 may be RF transceivers and the second transceivers 160-3, 160-4 may be corresponding RF transceivers. In some examples, the first transceivers 110-1, 110-2 and the second transceivers 160-1, 160-2 may be primary transceivers, and the first transceivers 110-3, 110-4 and the second transceivers 160-3, 160-4 may be secondary transceivers.

In some embodiments, the plurality of first transceivers 110 and the corresponding plurality of second transceivers 160 may exchange data signals using other wireless technologies, such as Bluetooth, Wi-Fi, Wi-Fi direct, long-term evolution (LTE), etc.

For example, the first transceiver 110-1 may be the NFMI transceiver and the second transceiver 160-1 may be the corresponding NFMI transceiver. Similarly, the first transceiver 110-2 may be the RF transceiver and the second transceiver 160-2 may be the corresponding RF transceiver. The first transceiver 110-3 may be an LTE transceiver and the second transceiver 160-3 may be the corresponding LTE transceiver. Similarly, the first transceiver 110-4 may be Wi-Fi transceiver and the second transceiver 160-4 may be the corresponding Wi-Fi transceiver. In some cases, the first transceiver 110-1 and the second transceiver 160-1 may be the primary transceivers, and the first transceivers 110-2 to 110-4 and the second transceivers 160-2 to 160-4 may be the secondary transceivers. In some cases, there may be a predetermined hierarchy for use of the secondary transceivers. For example, the first transceiver 110-2 and the corresponding second transceiver 160-2 may have a higher priority and may be prioritized in case of a failure of the primary transceivers. Further, the first transceiver 110-3 and the corresponding second transceiver 160-3 may have a lower priority than the first transceiver 110-2 and the corresponding second transceiver 160-2. The hierarchy for use of the secondary transceivers may be based on one or more of parameters, such as bandwidth required for the transmission of the data signals, a required data transmission rate, a power consumption of the at least one first and second transceivers 110, 160, etc.

In some embodiments, the first device 102 further includes a first controller 112. In some embodiments, the first controller 112 is communicably coupled to the first communication module 108. The first controller 112 may include a processor (not shown) and a memory (not shown) storing executable instructions. The processor may execute the instructions stored in the memory to implement a method or an algorithm. In some embodiments, the first power interface 104 may be configured to transmit a portion 106-3 of the external electrical power 106 to the first controller 112.

In some embodiments, the first controller 112 is configured to control the at least one first transceiver 110 of the first communication module 108 to transmit the data signals 114-1. In some embodiments, the first controller 112 is further configured to receive the data signals 114-2 from the at least one first transceiver 110 of the first communication module 108.

In some embodiments, the first device 102 further includes a first memory 116 communicably coupled to the first controller 112. The first memory 116 may include any computer-readable storage medium.

The first device 102 further includes an intrinsic barrier 190 disposed between and physically separating the first communication module 108 from the second communication module 158. In some embodiments, the intrinsic barrier 190 includes an air gap or a dielectric.

The intrinsic barrier 190 physically and electrically separates the first communication module 108 from the second communication module 158. In some cases, the intrinsic barrier 190 physically and electrically separates the at least one first transceiver 110 of the first communication module 108 from the at least one second transceiver 160 of the second communication module 158. As a result, the intrinsic barrier 190 may reduce a likelihood of an overcurrent, a surge current, or any other electrical overload from being transferred between the first communication module 108 and the second communication module 158.

In some embodiments, the intrinsic barrier 190 may separate the first communication module 108 and the second communication module 158 by a distance. The distance between the first communication module 108 and the second communication module 158 is shown schematically by a distance D in FIG. 1A. In some embodiments, the distance D between the first and second communication modules 108, 158 is less than or equal to 10 centimeters (cm). In some embodiments, the distance D between the first and second communication modules 108, 158 is less than or equal to 8 cm, less than or equal to 6 cm, less than or equal to 4 cm, less than or equal to 2 cm, or less than or equal to 1 cm.

The first communication module 108 and the second communication module 158 are configured to wirelessly exchange the data signals 192 therebetween. In some embodiments, the first communication module 108 and the second communication module 158 are configured to automatically exchange the data signals 192 therebetween.

The charging system 100 further includes a second device 152. In some embodiments, the second device 152 includes an article of personal protective equipment (PPE). In some other embodiments, the second device 152 may include another electronic device (e.g., a second electronic device 352-1 and/or a second electronic device 352-2 shown in FIG. 3A). In some embodiments, the electronic device may include, without limitations, a laptop, a mobile phone, a tablet, a camera, a personalized digital assistant, and the like.

The second device 152 includes a second power interface 154. The first power interface 104 and the second power interface 154 are configured to be electrically connected to each other to transfer electrical power between the first and second devices 102, 152. In the illustrated embodiment of FIG. 1A, the second power interface 154 of the second device 152 is configured to receive at least a portion 107 of the external electrical power 106 from the first power interface 104. Therefore, the first device 102 may be configured to provide the portion 107 of electrical power 106 from the external power source 180 to the second power interface 154 of the second device 152. The second power interface 154 may further provide the received portion 107 of the electrical power 106 to one or more components of the second device 152. In some embodiments, the second device 152 may include a battery 169. In such embodiments, the second power interface 154 may further charge the battery 169 via the received portion 107 of the electrical power 106.

In some embodiments, the first power interface 104 and the second power interface 154 may be galvanically isolated from each other. In such embodiments, the second power interface 154 may be configured to receive the at least the portion 107 of the external electrical power 106 from the first power interface 104 wirelessly.

The at least the portion 107 of the external electrical power 106 may be interchangeably referred to as “the transferred electrical power 107”. In some embodiments, the second device 152 includes at least one second barrier circuit 168 configured to limit the transferred electrical power 107 transferred from the first power interface 104 to the second power interface 154. In some embodiments, the at least one second barrier circuit 168 includes one or more of a resistor (not shown), a diode (not shown), and a fuse (not shown). In some embodiments, the at least one second barrier circuit 168 may include other electrical components, such as capacitors, inductances etc.

In some embodiments, the second device 152 further includes a second charging circuit 170. In some embodiments, the second charging circuit 170 includes the at least one second barrier circuit 168. In the illustrated embodiment of FIG. 1A, the second device 152 includes one second barrier circuit 168 and the second charging circuit 170 includes the one second barrier circuit 168. In some embodiments, the second charging circuit 170 may be communicably coupled to the battery 169. In such embodiments, the second charging circuit 170 may be configured to charge the battery 169 via the received portion 107 of the electrical power 106.

As discussed above, the at least one second barrier circuit 168 is configured to limit the transferred electrical power 107 transferred from the first power interface 104 to the second power interface 154. Therefore, the at least one second barrier circuit 168 may limit a maximum electrical power in the second device 152. Thus, the at least one second barrier circuit 168 may protect the second device 152 from damaging electrical conditions, such as an overcurrent, a surge current, and other electrical overloads.

In some embodiments, the second device 152 further includes a second controller 162. In some embodiments, the second controller 162 is communicably coupled to the second communication module 158. The second controller 162 may include a processor (not shown) and a memory (not shown) storing executable instructions. The processor may execute the instructions stored in the memory to implement a method or an algorithm. In some embodiments, the second power interface 154 may be configured to transmit a portion 107-1 of the transferred electrical power 107 to the second controller 162.

In some embodiments, the second controller 162 is configured to control the at least one second transceiver 160 of the second communication module 158 to transmit data signals 164-1. In some embodiments, the second controller 162 is further configured to receive data signals 164-2 from the at least one second transceiver 160 of the second communication module 158.

In some embodiments, the second device 152 further includes a second memory 166 communicably coupled to the second controller 162. The second memory 166 may include any computer-readable storage medium.

Due to the physical and electrical separation of the first communication module 108 from the second communication module 158 by the intrinsic barrier 190, there may not be a need for the first communication module 108 or the second communication module 158 to include intrinsic safety circuits. As a result, the data signals 192 may be exchanged between the first communication module 108 and the second communication module 158 at a higher data exchange rate than between conventional electronic devices including the intrinsic safety circuits including intrinsic safety components. Specifically, presence of the intrinsic safety circuits including the intrinsic safety components, such as fuses, resistors, diodes, etc., may negatively affect the data exchange rate between the conventional electronic devices. In some examples, the data signals 192 may be exchanged at a rate of up to about 100 megabits per second, up to about 1000 megabits per second, up to about 1 gigabit per second, up to about 6 gigabits per second, or up to about 10 gigabits per second.

Further, as the second barrier circuit 168 may be provided in the first and/or second device 102, 152, for example, in the second device 152, in order to provide protection to the first and/or second device 102, 152, against the overcurrent, the surge current or the other electrical overload conditions without negatively affecting the data exchange rate between the first and second devices 102, 152.

FIG. 1B illustrates a schematic block diagram of a charging system 101, according to another embodiment of the present disclosure. The charging system 101 of FIG. 1B is substantially similar to the charging system 100 of FIG. 1A. However, in the charging system 101, the first device 102 further includes a first power source 185. In some embodiments, the first power source 185 may include a DC power source, such as a battery, a fuel cell, an ultracapacitor, and/or any other suitable voltage source. In some embodiments, the battery may be any type of battery, such as a lead acid battery, coin cells, a lithium-ion battery, a nickel-metal battery, and/or any other rechargeable battery. In some embodiments, the ultracapacitor may include a supercapacitor, an electrochemical double layer capacitor, and/or any other electrochemical capacitor with high energy density.

In some embodiments, the first power interface 104 of the first device 102 is configured to be electrically connected to the first power source 185. In some embodiments, the first power interface 104 of the first device 102 is configured to receive a first electrical power 156 from the first power source 185. Further, in some embodiments, the second power interface 154 of the second device 152 is configured to receive at least a portion 157 of the first electrical power 156 from the first power interface 104.

In some embodiments, when the first power interface 104 and the second power interface 154 may be galvanically isolated from each other, the second power interface 154 may be configured to receive the at least the portion 157 of the first electrical power 156 from the first power interface 104 wirelessly.

In some embodiments, the first power interface 104 may be configured to transmit a portion 156-1 of the first electrical power 156 to the first communication module 108. In some embodiments, the first power interface 104 may be further configured to transmit a portion 156-2 of the first electrical power 156 to the second communication module 158. Furthermore, in some embodiments, the first power interface 104 may be configured to transmit a portion 156-3 of the first electrical power 156 to the first controller 112.

The at least the portion 157 of the first electrical power 156 may be interchangeably referred to as “the transferred electrical power 157”. In some embodiments, the at least one second barrier circuit 168 may be configured to limit the transferred electrical power 157 transferred from the first power interface 104 to the second power interface 154.

In some embodiments, the second power interface 154 may be configured to transmit a portion 157-1 of the transferred electrical power 157 to the second controller 162. Therefore, the first device 102 may be configured to provide the portion 157 of electrical power 156 from the first power source 185 to the second power interface 154 of the second device 152. The second power interface 154 may further provide the received portion 157 of the electrical power 156 to one or more components of the second device 152. In some embodiments, the second power interface 154 may further charge the battery 169 via the received portion 157 of the electrical power 156. In some embodiments, the second charging circuit 170 may be configured to charge the battery 169 via the received portion 157 of the electrical power 156.

In some embodiments, the charging system 101 may include the external power source 180 (shown in FIG. 1A) in addition to the first power source 185. In such cases, the external power source 180 may be configured to be electrically connected with the first power source 185 and/or the first power interface 104.

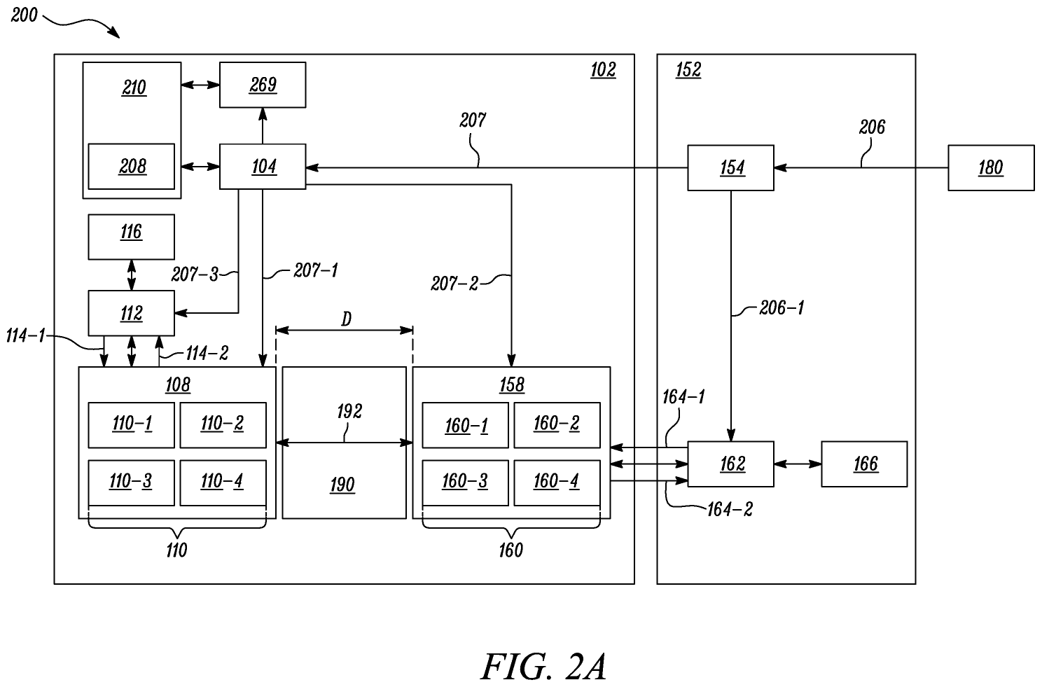

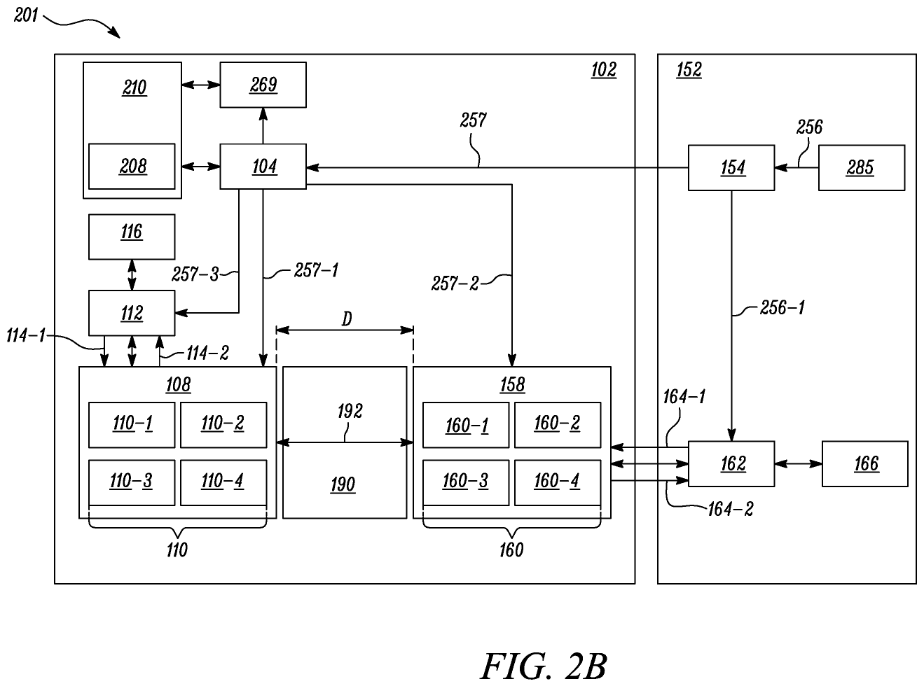

FIG. 2A illustrates a schematic block diagram of a charging system 200, according to another embodiment of the present disclosure. The charging system 200 of FIG. 2A is substantially similar to the charging system 100 of FIG. 1A. Common components between the charging system 100 of FIG. 1A and the charging system 200 are illustrated by same numerals. In the illustrated embodiment of FIG. 2A, the second power interface 154 of the second device 152 is configured to be electrically connected to the external power source 180. The second power interface 154 of the second device 152 is further configured to receive an external electrical power 206 from the external power source 180. In this embodiment, the first device 102 may include an article of personal protective equipment (PPE). In some other embodiments, the first device 102 may include another electronic device (e.g., the second electronic device 352-1 and/or the second electronic device 352-2 shown in FIG. 3A). In some embodiments, the electronic device may include, without limitations, a laptop, a mobile phone, a tablet, a camera, a personalized digital assistant, and the like. Further, the second device 152 may include an electronic device (e.g., the first electronic devices 302 shown in FIG. 3A). In some embodiments, the electronic device may include, without limitations, a USB adapter, charging adapter, a laptop, a mobile phone, a tablet, a camera, a personalized digital assistant, and the like.

In some embodiments, the second power interface 154 of the second device 152 may be galvanically isolated from the external power source 180. In such embodiments, the second power interface 154 of the second device 152 may be configured to receive the external electrical power 206 from the external power source 180 wirelessly.

In some embodiments, the second device 152 may further include the at least one second barrier circuit 168 (as shown in FIG. 1A). The at least one barrier circuit 168 may be configured to limit the external electrical power 206 transferred from the external power source 180 to the second power interface 154. Therefore, the at least one second barrier circuit 168 may limit a maximum electrical power in the second device 152. Thus, the at least one second barrier circuit 168 may protect the second device 152 from damaging electrical conditions, such as an overcurrent, a surge current, and other electrical overloads.

In some embodiments, the second power interface 154 may be configured to transmit a portion 206-1 of the external electrical power 206 to the second controller 162.

In some embodiments, the first power interface 104 of the first device 102 is configured to receive at least a portion 207 of the external electrical power 206 from the second power interface 154. Therefore, the second device 152 may be configured to provide the portion 207 of the electrical power 206 from the external power source 180 to the first power interface 104 of the first device 102. The first power interface 104 may further provide the received portion 207 of the electrical power 206 to one or more components of the first device 102. In some embodiments, the first device 102 may include a battery 269. In such embodiments, the first power interface 104 may further charge the battery 269 via the received portion 207 of the electrical power 206.

The at least the portion 207 of the external electrical power 206 may be interchangeably referred to as “the transferred electrical power 207”. In some embodiments, the first device 102 includes at least one first barrier circuit 208 configured to limit the transferred electrical power 207 transferred from the second power interface 154 to the first power interface 104. In some embodiments, the at least one first barrier circuit 208 includes one or more of a resistor (not shown), a diode (not shown), and a fuse (not shown). In some embodiments, the at least one first barrier circuit 208 may include other electrical elements, such as capacitors, inductances etc.

In some embodiments, the first device 102 further includes a first charging circuit 210. In some embodiments, the first charging circuit 210 includes the at least one first barrier circuit 208. In the illustrated embodiment of FIG. 2A, the first device 102 includes one first barrier circuit 208 and the first charging circuit 210 includes the one first barrier circuit 208. In some embodiments, the first charging circuit 210 may be communicably coupled to the battery 269. In such embodiments, the first charging circuit 210 may be configured to charge the battery 269 via the received portion 207 of the electrical power 206.

As discussed above, the at least one first barrier circuit 208 is configured to limit the transferred electrical power 207 transferred from the second power interface 154 to the first power interface 104. Therefore, the at least one first barrier circuit 208 may limit a maximum electrical power in the first device 102. Thus, the at least one first barrier circuit 208 may protect the first device 102 from damaging electrical conditions, such as an overcurrent, a surge current, and other electrical overloads.

In some embodiments, the second power interface 154 and the first power interface 104 may be galvanically isolated from each other. In such embodiments, the first power interface 104 may be configured to receive the at least the portion 207 of the external electrical power 206 from the second power interface 154 wirelessly.

In some embodiments, the first power interface 104 may be configured to transmit a portion 207-1 of the transferred electrical power 207 to the first communication module 108. Further, in some embodiments, the first power interface 104 may be configured to transmit a portion 207-2 of the transferred electrical power 207 to the second communication module 158. Furthermore, in some embodiments, the first power interface 104 may be configured to transmit a portion 207-3 of the transferred electrical power 207 to the first controller 112.

As discussed above, due to the physical and electrical separation of the first communication module 108 from the second communication module 158 by the intrinsic barrier 190, there may not be a need for the first communication module 108 or the second communication module 158 to include intrinsic safety circuits. As a result, the data signals 192 may be exchanged between the first communication module 108 and the second communication module 158 at a higher data exchange rate than between conventional electronic devices including the intrinsic safety circuits including intrinsic safety components. Specifically, presence of the intrinsic safety circuits including the intrinsic safety components, such as fuses, resistors, diodes, etc., may negatively affect the data exchange rate between the conventional electronic devices. In some examples, the data signals 192 may be exchanged at a rate of up to about 100 megabits per second, up to about 1000 megabits per second, up to about 1 gigabit per second, up to about 6 gigabits per second, or up to about 10 gigabits per second.

Further, as the first barrier circuit 208 may be provided in at least one of the first and second device 102, 152, for example, in the first device 102, in order to provide protection to the first and second device 102, 152, against the overcurrent, the surge current or the other electrical overload conditions without negatively affecting the data exchange rate between the first and second devices 102, 152.

FIG. 2B illustrates a schematic block diagram of a charging system 201, according to another embodiment of the present disclosure. The charging system 201 of FIG. 2B is substantially similar to the charging system 200 of FIG. 2A. However, in the charging system 201, the second device 152 further includes a second power source 285. In some embodiments, the second power source 285 may include a DC power source. The second power source 285 may be substantially similar to the first power source 185 shown in FIG. 1B.

In some embodiments, the second power interface 154 of the second device 152 is configured to be electrically connected to the second power source 285. In some embodiments, the second power interface 154 of the second device 152 is configured to receive a second electrical power 256 from the second power source 285. Further, in some embodiments, the first power interface 104 of the first device 102 is configured to receive at least a portion 257 of the second electrical power 256 from the second power interface 154.

In some embodiments, when the second power interface 154 and the first power interface 104 may be galvanically isolated from each other, the first power interface 104 may be configured to receive the at least the portion 257 of the second electrical power 256 from the second power interface 154 wirelessly.

In some embodiments, the second power interface 154 may be configured to transmit a portion 256-1 of the second electrical power 256 to the second controller 162.

The at least the portion 257 of the second electrical power 256 may be interchangeably referred to as “the transferred electrical power 257”. In some embodiments, the at least one first barrier circuit 208 may be configured to limit the transferred electrical power 257 transferred from the second power interface 154 to the first power interface 104.

In some embodiments, the first power interface 104 may be configured to transmit a portion 257-1 of the transferred electrical power 257 to the first communication module 108. Further, in some embodiments, the first power interface 104 may be configured to transmit a portion 257-2 of the transferred electrical power 257 to the second communication module 158. Furthermore, in some embodiments, the first power interface 104 may be configured to transmit a portion 257-3 of the transferred electrical power 257 to the first controller 112. Therefore, the second device 152 may be configured to provide the portion 257 of the second electrical power 256 from the second power source 285 to the first power interface 104 of the first device 102. The first power interface 104 may further provide the received portion 257 of the second electrical power 256 to one or more components of the first device 102. In some embodiments, the first power interface 104 may further charge the battery 269 via the received portion 257 of the second electrical power 256. In some embodiments, the first charging circuit 210 may be configured to charge the battery 269 via the received portion 257 of the second electrical power 256.

In some embodiments, the charging system 201 may include the external power source 180 (shown in FIG. 2A) in addition to the second power source 285. In such cases, the external power source 180 may be configured to be electrically connected with the second power source 285 and/or the second power interface 154.

FIG. 3A illustrates an exemplary representation of a charging system 300. The charging system 300 includes the first and second devices 102, 152 according to the charging system 100 of FIG. 1A.

In some embodiments, the second device 152 includes the second electronic device 352-1. In some other embodiments, the second device 152 includes the second electronic device 352-2. In some embodiments, the second electronic devices 352-1, 352-2 may include, without limitations, laptops, mobile phones, tablets, cameras, personalized digital assistants, and the like. In some embodiments, the second electronic devices 352-1, 352-2 may be articles of PPE.

In some embodiments, the second device 152 further includes interface devices 354-1, 354-2. Specifically, the second electronic device 352-1 may be configured to couple with the interface device 354-1 and the second electronic device 352-2 may be configured to couple with the interface device 354-2.

In yet other embodiments, the second device may be a single electronic device, i.e., the second device 152 may not include separate second electronic device and an interface device.

In some embodiments, the interface devices 354-1, 354-2 may provide an interface to exchange electrical power and/or data signals with the respective second electronic devices 352-1, 352-2. In some embodiments, the interface devices 354-1, 354-2 may exchange the electrical power and/or the data signals with the respective second electronic devices 352-1, 352-2 wirelessly. For example, the interface device 354-1 may exchange the electrical power and/or the data signals with the second electronic device 352-1 wirelessly. In some embodiments, the interface devices 354-1, 354-2 may exchange the electrical power and/or the data signals with the respective second electronic devices 352-1, 352-2 through wired connections. In some examples, the interface device 354-2 may exchange the electrical power and/or the data signals with the second electronic device 352-2 through the wired connections. For example, the wired connections may include first contacts 356-1 provided on the second electronic device 352-2, and second contacts 356-2 provided on the interface device 354-2. In some embodiments, when the first and second contacts 356-1, 356-2 are connected, exchange of the electrical power and/or the data signals may occur between the second electronic device 352-2 and the interface device 354-2.

In some embodiments, the first device 102 includes the first electronic device 302. In some embodiments, the first electronic device 302 may be configured to receive electrical power and/or data signals from an external device (not shown) and transmit at least a portion of a received electrical power and/or data signals to the second electronic devices 352-1, 352-2. In some cases, the first electronic device 302 may be electrically connected to the external power source 180 (depicted in FIG. 1A). In the illustrated embodiment of FIG. 3A, the first electronic device 302 may be a charging adapter 302-1. The charging adapter 302-1 may be configured to be plugged into an external power source 180 (not shown), such as an electrical socket to receive electrical power from the external power source 180.

In some cases, the first electronic device 302 may be connected to the external device. In some examples, the external device may include, without limitations, a laptop, a mobile phone, a tablet, a camera, a personalized digital assistant, and the like. The external device may be configured to exchange electrical power and/or data signals with the first electronic device 302. In the illustrated embodiment of FIG. 3A, the first electronic device 302 may be a USB adapter 302-2. The USB adapter 302-2 may be configured to be plugged into a USB receptacle (not shown) of the external device. The USB adapter 302-2 may be configured to receive electrical power and/or data signals.

In some embodiments, the charging adapter 302-1 may be configured to transfer electrical power and/or data signals to the second electronic device 352-1 or the second electronic device 352-2. In some embodiments, the USB adapter 302-2 may be configured to transfer electrical power and/or data signals with the second electronic device 352-1 or the second electronic device 352-2. Further, the second electronic device 352-1 or the second electronic device 352-2 may include barrier circuits in order to provide protection to the second device 152, against the overcurrent, the surge current or the other electrical overload conditions without negatively affecting the data exchange rate between the first and second devices 102, 152.

FIG. 3B illustrates a detailed schematic block diagram for the charging system 300 of FIG. 3A. In some embodiments, FIG. 3B illustrates an exemplary schematic block diagram for the charging system 300 of FIG. 3A, wherein the first electronic device 302 (shown in FIG. 3A) is the USB adapter 302-2.

In some embodiments, the USB adapter 302-2 includes the first controller 112, the first communication module 108, the second communication module 158 and the intrinsic barrier 190. The data signals 192 may be wirelessly exchanged between the first and second communication modules 108, 158.

The first power interface 104 may be electrically connected with the second power interface 154 and may be configured to transfer the portion 107 of the external electrical power 106 to the second power interface 154. In some embodiments, the first power interface 104 and the second power interface 154 may be connected to a common ground 320. The external power source 180 may be configured to be electrically connected with the first power interface 104 to provide the external electrical power 106.

In some embodiments, the second power interface 154 may be the interface device 354-1 or the interface device 354-2 (shown in FIG. 3A). Thus, the second power interface 154 may receive an electrical power and may supply a portion of the electrical power to the second electronic devices 352-1, 352-2 (shown in FIG. 3A) to charge the second electronic devices 352-1, 352-2. In some embodiments, the interface devices 354-1, 354-2 may include the second controller 162. In some other embodiments, the second electronic devices 352-1. 352-2 may include the second controller 162.

As the intrinsic barrier 190 is disposed between and physically separates the first communication module 108 from the second communication module 158, the first communication module 108 and the second communication module 158 may not require the intrinsic safety circuits including the intrinsic safety components in order to prevent an overcurrent, a surge current, or any other electrical overload from being transferred between the first communication module 108 and the second communication module 158. As discussed above, the presence of the intrinsic safety circuits including the intrinsic safety components may negatively affect the data exchange rate between two components. In other words, the intrinsic safety components may inhibit high speed data transmission between the two components. Since the first communication module 108 and the second communication module 158 do not require such intrinsic safety circuits, the data signals 192 may be exchanged between the first communication module 108 and the second communication module 158 at a high data exchange rate while the first and second devices 102, 152 are intrinsically safe.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for case of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an clement, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better case of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM). FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software. firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, millimeter wave, and microwave, then the coaxial cable, fiber optic cable, twisted pair, DSL, or wireless technologies such as infrared, radio, millimeter wave, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing. interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A charging system comprising:
a first device, wherein the first device comprises:
a first power interface;
a first communication module, wherein the first communication module comprises at least one first transceiver;
a second communication module, wherein the second communication module comprises at least one second transceiver; and
an intrinsic barrier disposed between and physically separating the first communication module from the second communication module, wherein the first communication module and the second communication module are configured to wirelessly exchange data signals therebetween; and
a second device comprising a second power interface;
wherein the first power interface and the second power interface are configured to be electrically connected to each other to transfer electrical power between the first and second devices.

2. The charging system of claim 1, wherein the first device further comprises a first power source, wherein the first power interface of the first device is configured to be electrically connected to the first power source and configured to receive a first electrical power from the first power source, and wherein the second power interface of the second device is configured to receive at least a portion of the first electrical power from the first power interface.

3. The charging system of claim 1, wherein the first power interface of the first device is configured to be electrically connected to an external power source and configured to receive an external electrical power from the external power source, and wherein the second power interface of the second device is configured to receive at least a portion of the external electrical power from the first power interface.

4. The charging system of claim 2, wherein the second device comprises at least one second barrier circuit configured to limit a transferred electrical power transferred from the first power interface to the second power interface, and wherein the at least one second barrier circuit comprises one or more of a resistor, a diode, and a fuse.

5. The charging system of claim 4, wherein the second device further comprises a second charging circuit, and wherein the second charging circuit comprises the at least one second barrier circuit.

6. The charging system of claim 2, wherein the second device comprises an article of personal protective equipment (PPE).

7. The charging system of claim 1, wherein the second device comprises a second power source, wherein the second power interface of the second device is configured to be electrically connected to the second power source and configured to receive a second electrical power from the second power source, and wherein the first power interface of the first device is configured to receive at least a portion of the second electrical power from the second power interface.

8. The charging system of claim 1, wherein the second power interface of the second device is configured to be electrically connected to an external power source and configured to receive an external electrical power from the external power source, and wherein the first power interface of the first device is configured to receive at least a portion of the external electrical power from the second power interface.

9. The charging system of claim 7, wherein the first device comprises at least one first barrier circuit configured to limit a transferred electrical power transferred from the second power interface to the first power interface, and wherein the at least one first barrier circuit comprises one or more of a resistor, a diode, and a fuse.

10. The charging system of claim 9, wherein the first device further comprises a first charging circuit, and wherein the first charging circuit comprises the at least one first barrier circuit.

11. The charging system of claim 7, wherein the first device comprises an article of personal protective equipment (PPE).

12. The charging system of claim 1, wherein the first device further comprises a first controller, wherein the first controller is communicably coupled to the first communication module, wherein the first controller is configured to control the at least one first transceiver of the first communication module to transmit data signals, and wherein the first controller is further configured to receive data signals from the at least one first transceiver of the first communication module.

13. The charging system of claim 12, wherein the first device further comprises a first memory communicably coupled to the first controller.

14. The charging system of claim 1, wherein the second device further comprises a second controller, wherein the second controller is communicably coupled to the second communication module, wherein the second controller is configured to control the at least one second transceiver of the second communication module to transmit data signals, and wherein the second controller is further configured to receive data signals from the at least one second transceiver of the second communication module.

15. The charging system of claim 14, wherein the second device further comprises a second memory communicably coupled to the second controller.

16. The charging system of claim 1, wherein the at least one first transceiver comprises a plurality of first transceivers.

17. The charging system of claim 1, wherein the at least one second transceiver comprises a plurality of second transceivers.

18. The charging system of claim 1, wherein each of the at least one first transceiver and the at least one second transceiver is a near-field magnetic induction (NFMI) transceiver.

19. The charging system of claim 1, wherein each of the at least one first transceiver and the at least one second transceiver is a radio-frequency (RF) transceiver.

20. The charging system of claim 1, wherein the intrinsic barrier comprises an air gap or a dielectric.

21. (canceled)
